(19) United States
(12) Patent Application Publication
(10) Pub. No.: US 2007/0217205 A1
(43) Pub. Date: Sep. 20, 2007

(54) DURABLE FIBEROPTIC LIGHTING ARRANGEMENT

(76) Inventors: Roger F. Buelow II, Gates Mills, OH (US); John M. Davenport, Middleburg Heights, OH (US); Kevin R. Reagan, Coppell, TX (US); Gregory P. Frankiewicz, Mayfield Heights, OH (US); Robert H. Caywood, Vermillion, OH (US); Robert M. Knauer, Carrollton, TX (US)

Correspondence Address: BRUZGA & ASSOCIATES, 11 BROADWAY, SUITE 715, NEW YORK, NY, 10004, US

(21) Appl. No.: 11/533,261

(22) Filed: Sep. 19, 2006

Related U.S. Application Data
(60) Provisional application No. 60/736,681, filed on Nov. 15, 2005.

(51) Int. Cl. F21V 3/00

(52) U.S. Cl. 362/311

(57) ABSTRACT

Durable lighting arrangement comprising a housing of generally cylindrical shape with a forward end for emitting light and a rearward end is disclosed. A light-transparent aperture located towards the forward end of the housing. A light-transmitting conduit enters the housing rearwardly of the light-transparent aperture with at least one plate that is mounted to the housing. The plate is mounted perpendicular to a longitudinal axis of the housing that has one or more light apertures. The light apertures provide structural reinforcement to the generally forward area of said housing.

### FIELD OF THE INVENTION

The present invention relates to a fiberoptic lighting arrangement that is especially durable and, therefore able to withstand considerable crushing and impact forces.

### BACKGROUND OF THE INVENTION

One type of lighting arrangement is used to illuminate docks, where trucks load and unload material. Such lights are called “dock lights,” and are used to aid vision when loading or unloading semi trailers and other vehicles on shipping docks.

Conventional “dock light” lighting arrangements use standard light fixtures with a so-called parabolic aluminized reflector (PAR) type lighting (or similar), quartz halogen or incandescent lamp made of glass. The problem with such arrangements is that they are not very durable. Operators of forklifts who load and unload material from trucks, are typically pressed for time. A typical forklift is that sold under the trademark TOWMOTOR. The result is that forklift operators often move too fast, and sometimes carelessly. Often, dock lights suffer a destructive, jolting or even crushing impact either from the forklift or its load, resulting in breaking of the glass of the lamp or deformation and destruction of the lighting arrangement. The breaking of the glass can prove dangerous to both the workers and forklift operators. Even if a safety cover is used when consumable food is loaded or unloaded, the pieces of glass can be hazardous to the consumable food.

The effect of the breaking of the glass of the quartz halogen or incandescent fixtures results in the catastrophic failure of the lamp. This result in problems first, a failed light result in the work being halted and the inability of any container to be loaded or unloaded at the docks until a replacement light is found. This costs time and money, because workers often are idled while maintenance personnel replace a broken lamp and clean up any broken glass, which typically takes about 30 minutes. Second, even though a Plexiglas-brand protection lens may be used in a conventional dock light, it is still possible for broken glass to contaminate the area during a lamp change or, sometimes, a Plexiglas-brand safety cover is missing. Thus, the rigorous use of the light fixtures destroys a standard lamp used in the light fixtures.

It would be desirable to provide a light arrangement that produces the amount of light needed in areas such as docks while consuming less power than the above-mentioned standard lamps currently used in presently available products. It would also be desirable that the light arrangement is exceedingly durable so that it can withstand jolting or even crushing forces that would destroy conventional dock light arrangements or light sources in said arrangements.

### BRIEF SUMMARY OF THE INVENTION

In accordance with one form of invention, a durable lighting arrangement is provided which comprises a housing of generally cylindrical shape with a forward end for emitting light and a rearward end. A light-transparent aperture is located towards the forward end of the housing. A light-transmitting conduit enters the housing rearwardly of the light-transparent aperture with at least one plate that is mounted to the housing. The plate is mounted perpendicular to a longitudinal axis of the housing that has one or more light apertures. The light apertures provide structural reinforcement to the generally forward area of said housing.

The invention provides a light arrangement that is exceedingly durable, efficient and can withstand jolting and even crushing forces that would destroy a conventional dock light arrangement. The invention also prevents any injuries that can be caused by the broken glass of the lamp used as the light source in the currently available products.

### BRIEF DESCRIPTION OF THE DRAWINGS

FIG. 1 is a side view of a durable fiberoptic lighting arrangement in accordance with the invention, shown partially cutaway.

FIG. 2A is a cross-sectional view taken at Arrows 2A-2A in FIG. 1, and FIG. 2B is an enlargement of the circled portion in FIG. 2A labeled 28.

FIG. 3 is a view of the right-hand face of the lighting fixture of FIG. 1, partially cut away to reveal mounting hardware.

FIG. 5 is a side view of a plate-and-light arrangement used in the lighting arrangement of FIG. 1

FIG. 6 is an enlarged detail view of the upper light fixture of FIG. 2 and associated structure.

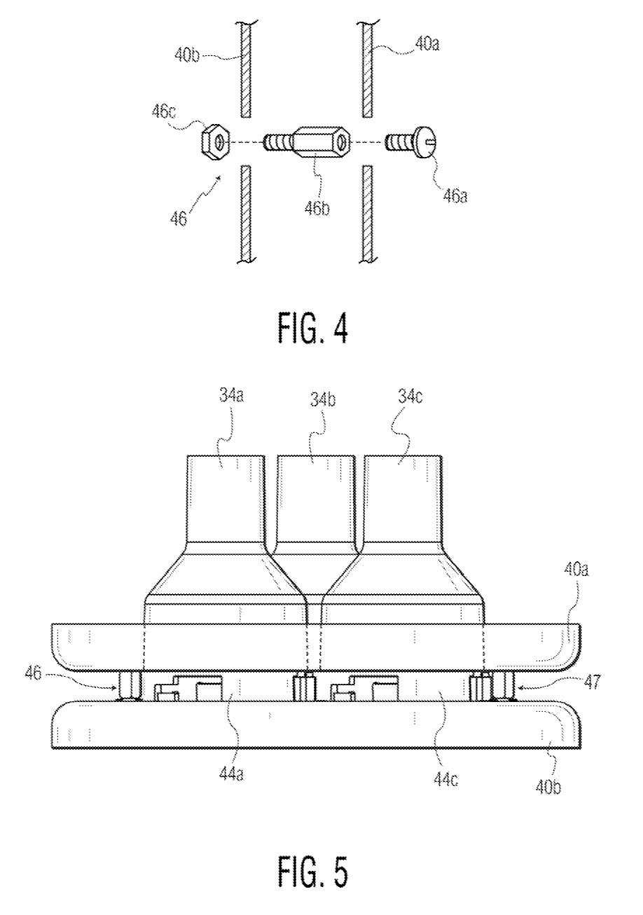

FIG. 4 shows hardware used to mount together the two plates shown in FIG. 5 for instance.

FIG. 7 is a perspective, exploded view of a bayonet assembly, light pipe, receiver assembly and lens in accordance with the invention.

FIG. 8A is a side view of the bayonet assembly and light pipe of FIG. 7; FIG. 8B is a sectional view of FIG. 8A taken at Arrows 8B-8B in FIG. 8A; and FIG. 8C is an enlargement of the circled portion of FIG. 8B labeled FIG. 8C.

FIG. 9A is a side view of the receiver assembly of FIG. 7; FIG. 98 is a sectional view of FIG. 9A taken at Arrows 9B-9B in FIG. 9A; and FIG. 9C is an enlargement of the circled portion of FIG. 9B labeled FIG. 9C.

FIGS. 10A-10C are perspective views, partially cutaway, of initial relative positions of the bayonet and receiver assemblies of FIG. 7 for attaining different light beam spreads.

FIG. 11 is a perspective view of the bayonet assembly of FIG. 7.

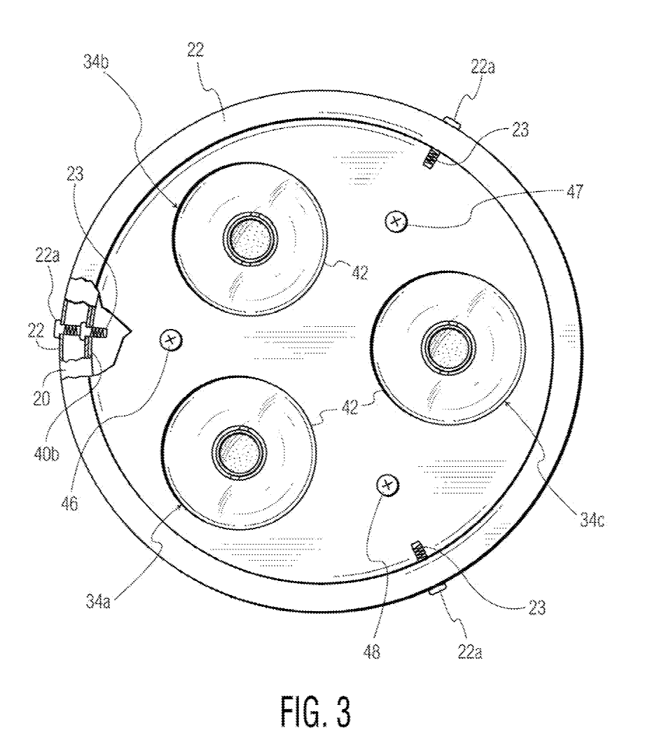

FIG. 12A is a sectional, perspective view of the receiver assembly of FIG. 7; and FIG. 3B is an enlargement of the circled portion in FIG. 12A labeled FIG. 12B.

FIG. 13A is a perspective view of a bayonet assembly and a receiver assembly, with the receiver assembly shown without the surface on which positioning pads and circumferential flange stops are mounted, for simplicity of illustration; and FIG. 13B is an enlargement of the circled portion in FIG. 13A labeled FIG. 13B.

FIGS. 14A-14C show perspective views of a bayonet assembly and receiver assembly in various stages of interconnection for selecting a 15-degree light beam spread, with outer portions of the bayonet assembly removed or broken away to show more clearly positioning pads and attached circumferential flange stops of the receiver assembly, and FIG. 14D is an enlargement of the circled portion in FIG. 14C labeled FIG. 14D.

FIG. 14E is a perspective view of a portion of the bayonet and receiver assemblies of FIG. 14, partially in cross section with an outer portion of the bayonet assembly removed to show more clearly a radial-bearing region; and FIG. 14F is an enlargement of the circled portion in FIG. 14E labeled FIG. 14F, shown partially broken away.

FIG, 14G is a perspective view of the bayonet and receiver assemblies of FIG. 14. The figure shows the receiver assembly partially in cross section and with an outer portion removed in the vicinity of the bayonet assembly to portray more clearly a radial-bearing section of the receiver assembly.

### DETAILED DESCRIPTION OF THE PREFERRED EMBODIMENTS

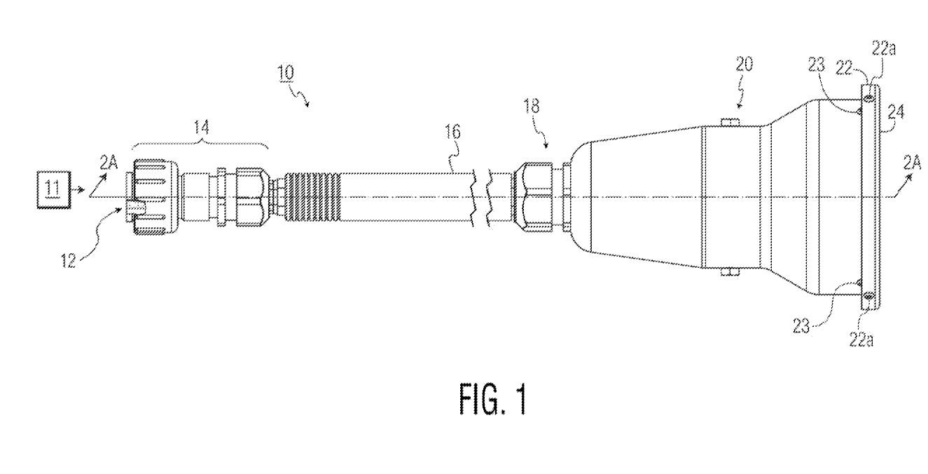

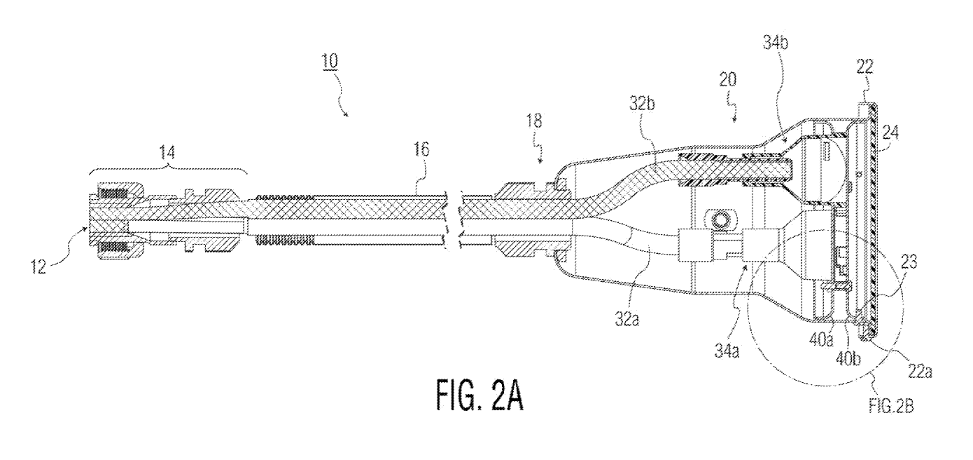

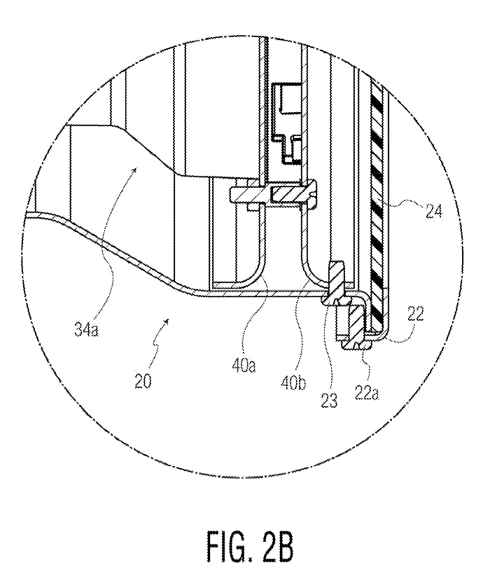

FIGS. 1 and 2 show a durable fiberoptic lighting arrangement 10 according to the present invention. Lighting arrangement 10 includes a standard fiber bundle 12 passing through a bushing 14, a protective armor 16, and a second bushing 18. Fiber bundle 12 may comprise three fibers, for instance, each of which may be multi-stranded or each of which may be a single, large-core fiber. A light source 11 provides light to lighting arrangement 10. Fiber 12 is received into bushing 14 and secured in the bushing using an adhesive. The second bushing 18 is attached to a housing 20. Bushing 14 is preferably mounted in fixed relation to a sturdy support, such as a wall. Armor 16 is preferably flexible, such as a flexible plastic shield, but could alternatively be formed of more sturdy material such as metal. Housing, of thickness 1.23-mm, 20 is preferably of generally cylindrical shape, most of which is formed as a body of rotation about a central longitudinal axis (not shown), and may be made of a metal such as stainless steel. A transparent lens 24 is held onto housing 20 by a metal retainer 22, which is secured to the housing by bolts 22a, for instance. By way of example, lens 24 may be a piano-convex lens, an aspherical lens, a holographic lens, a Fresnel lens or a flat lens, made from either glass or plastic. A pair of plates 40a and 40b are shown at the right-hand end of housing 22.

Fiberoptic lighting arrangement 10 may typically be suspended from a mount such as a Model D1-42-ARM sold by Phoenix Docklite of Milwaukee, Wis.

FIG. 2A shows fibers 32a and 32b passing into light fixtures 34a and 34b, respectively. Light fixtures 34a and 34b typically contain—as shown in FIG. 7—a bayonet assembly 50 and a receiver assembly 52 combined together. Bayonet assembly 50 and receiver assembly 52 are described in connection with FIGS, 7 to 14G below.

FIG. 28 shows bolt 22a securing retainer 22 to housing 20, as well as bolt 23, securing plate 40b to housing,

A light source (not shown) is remotely located to keep the lighting arrangement safe from damage that may be caused by destructive impacts to a light source of the lighting arrangement. The lighting arrangement preferably does not contain any destructible structure or material inside, such as glass. A standard EFO-AG or FFO-AD Illuminator sold by Fiberstars, Inc. of Solon, Ohio, can be used as a light source to provide light to the arrangement. The standard EFO-AG or EFO-AD illuminator consists of two 500-strand bundles of poly-methacrylic acid (PMMA) (one for each side of the illuminator), which hold the bundles in place with the optics. Currently each 500-strand bundle consists of three 167-strand whips. The large-core plastic fiber, or the bundle of PMMA fibers, is protected by the lighting arrangement housing as well as any lenses that are used as apertures.

FIG. 3 shows the right-hand end of plate 40b. Light fixtures 34a, 34b and 34c are aligned in light-transparent apertures 42 in plate 40b. A Lens 24 is held to the housing (not shown) by bolts 22a. Light fixtures 34a, 34b, and 34c are mounted to the plate 40b using preferred hardware 46, 47 and 48. Exemplary hardware 46 is shown in FIG. 4, comprising a bolt 46a that screws into a part 46b, onto which a nut 46c is screwed. Hardware 47 and 48 may be the same as hardware 46. FIG. 3 also shows bolts 22a securing retainer 22 to housing 20 as well as bolts 23 securing plate 40b to the housing.

FIG. 5 shows light fixtures 34a, 34b and 34d with respective radially extending mounting structures 44a and 44c, for instance, pinched between plates 40a and 40b. In this way, light fixtures 34a, 34b and 34c are mounted to the foregoing plates. Preferred mounting hardware 46a and 46b and a similar, third hardware (not shown) mount together the plates.

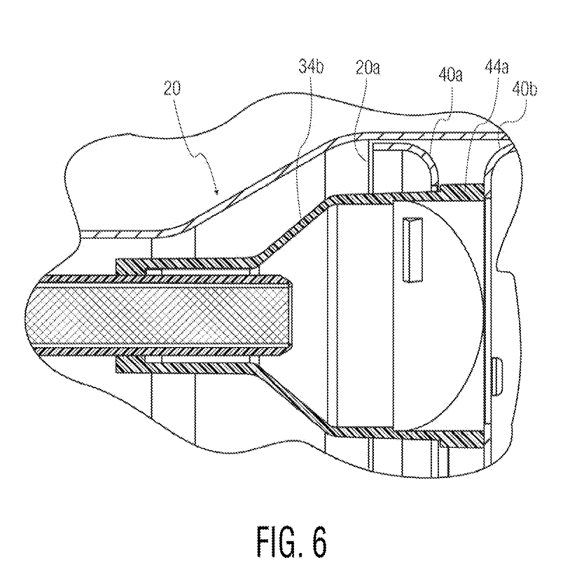

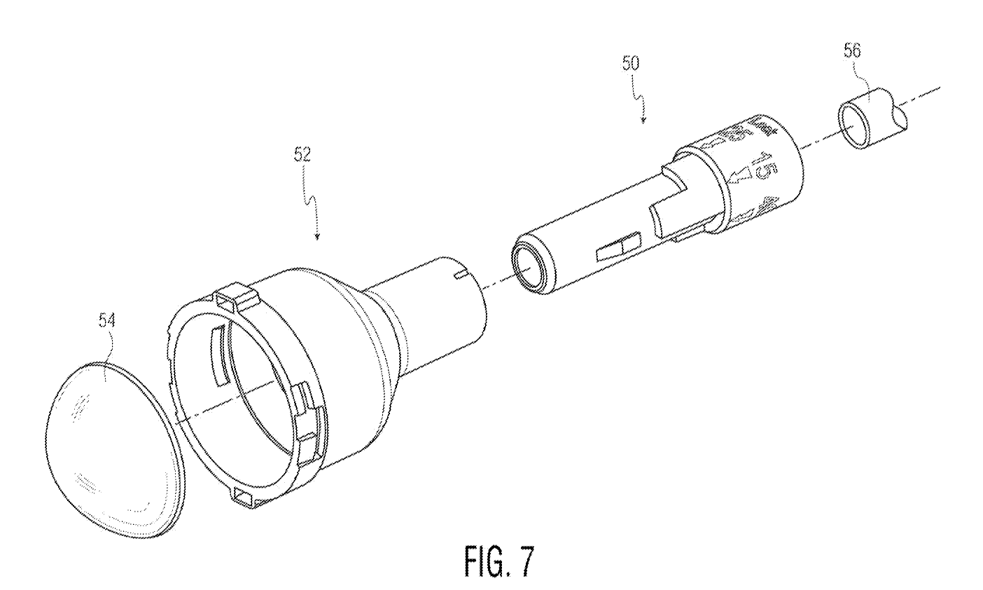

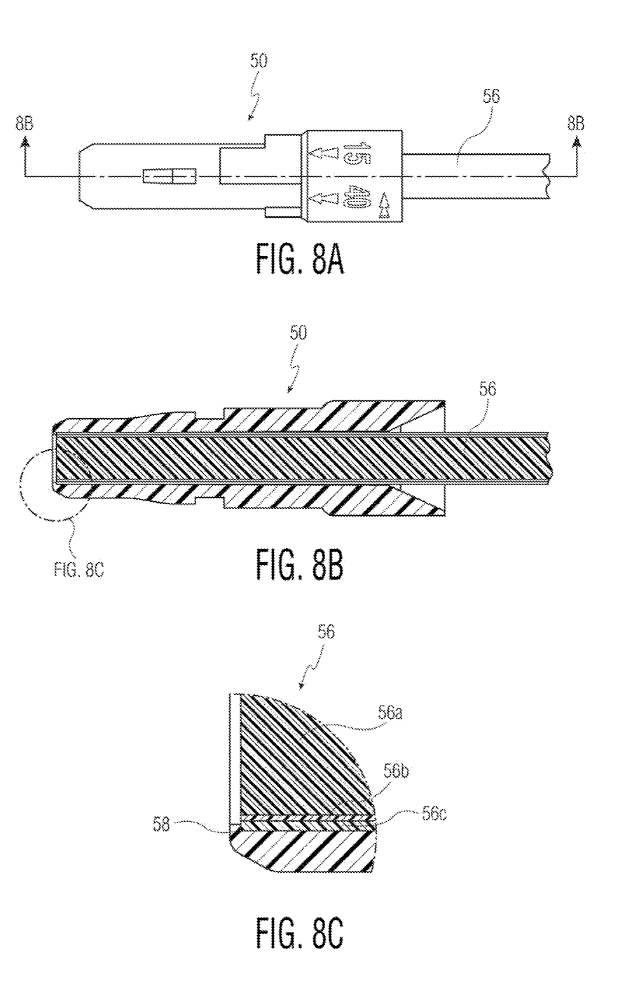

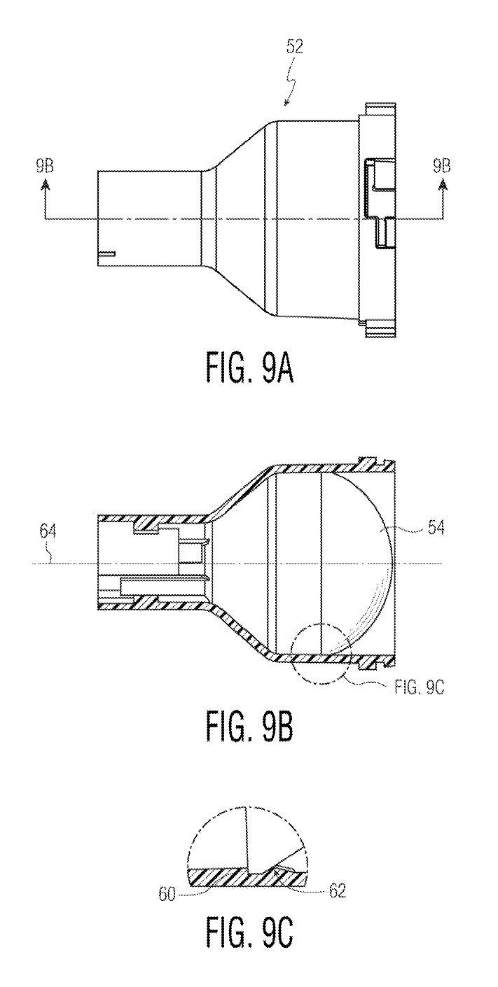

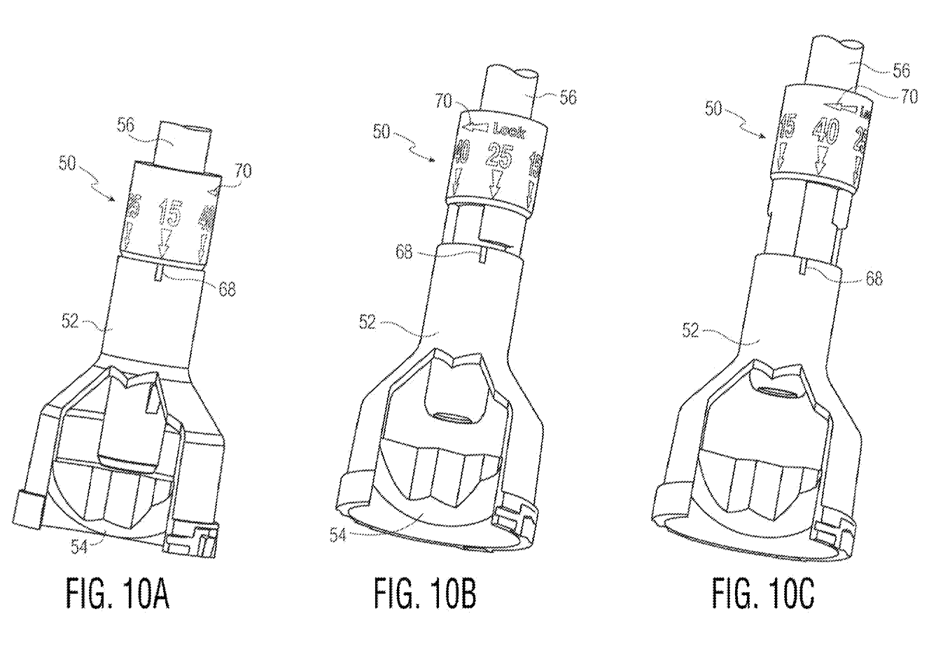

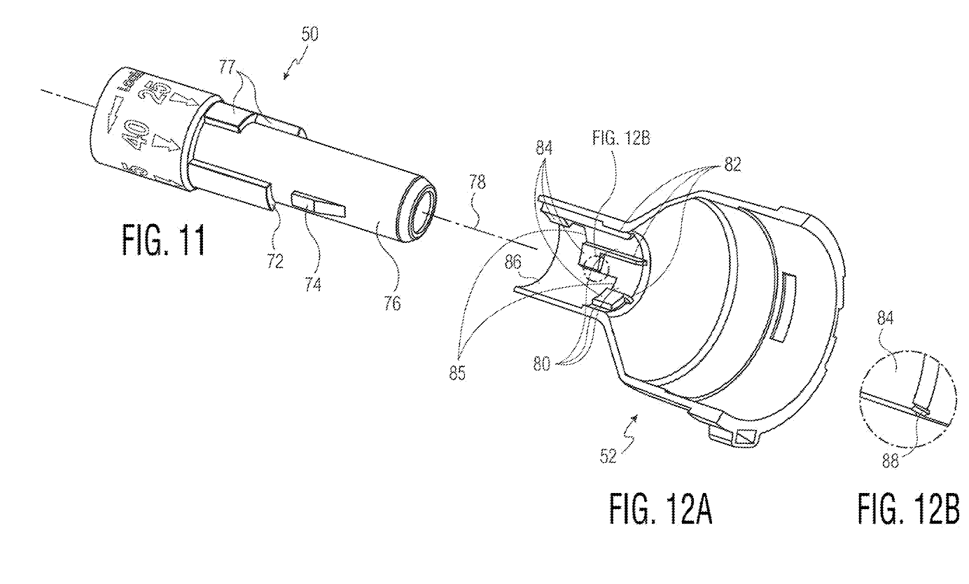

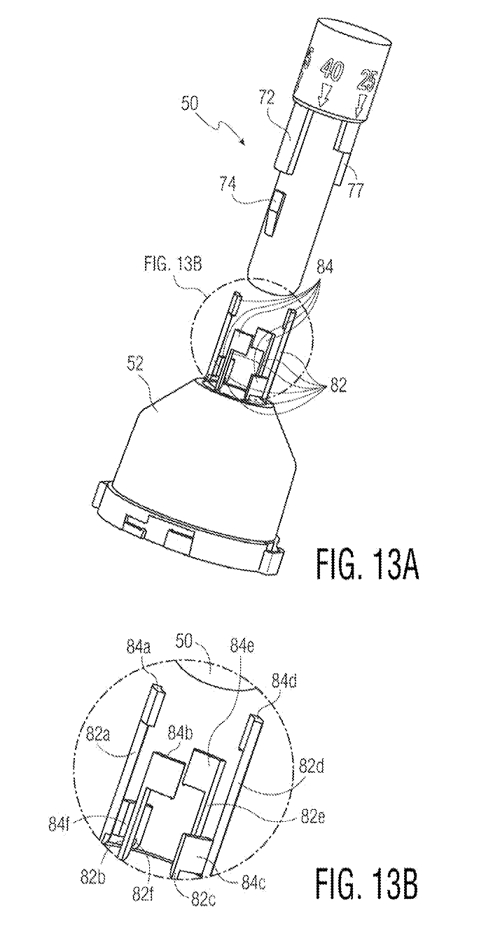

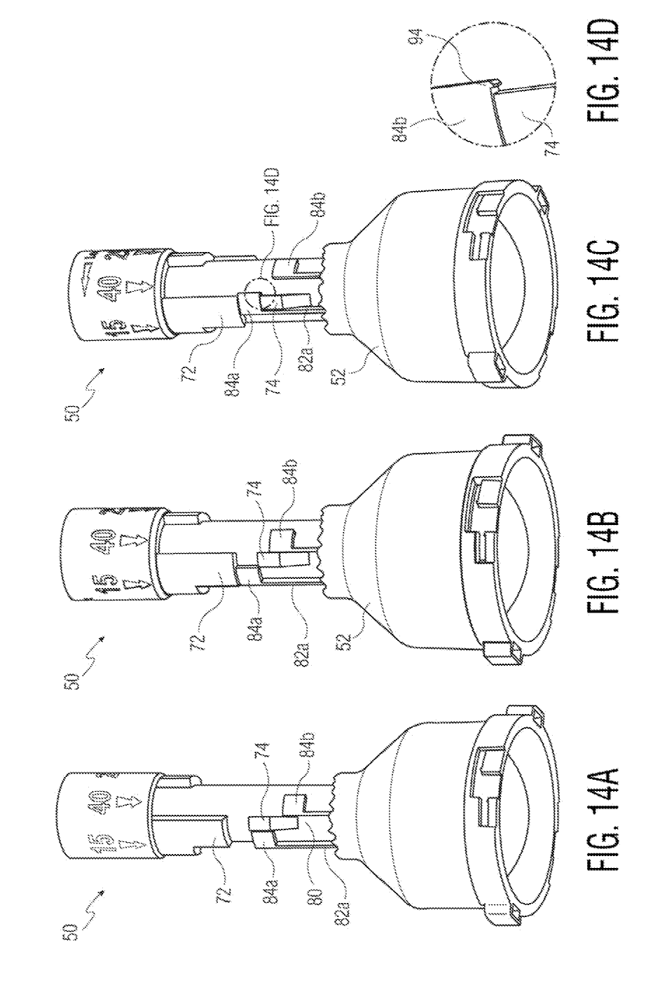

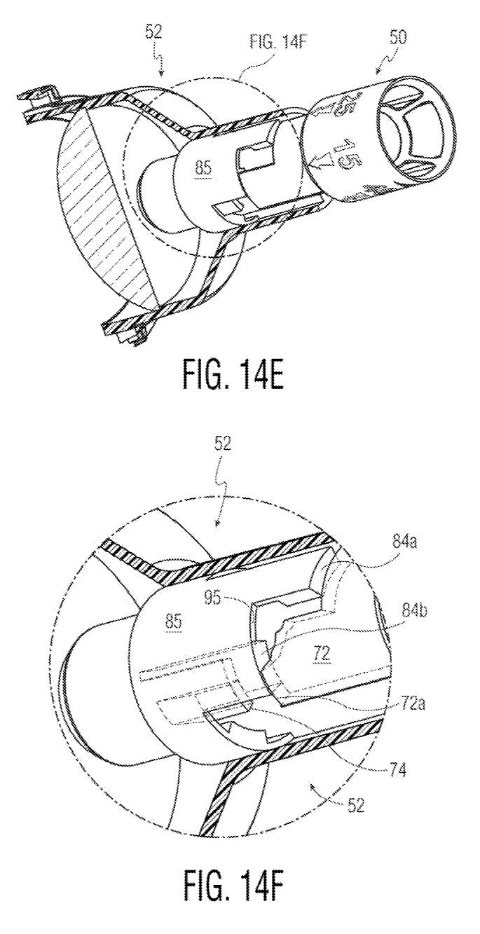

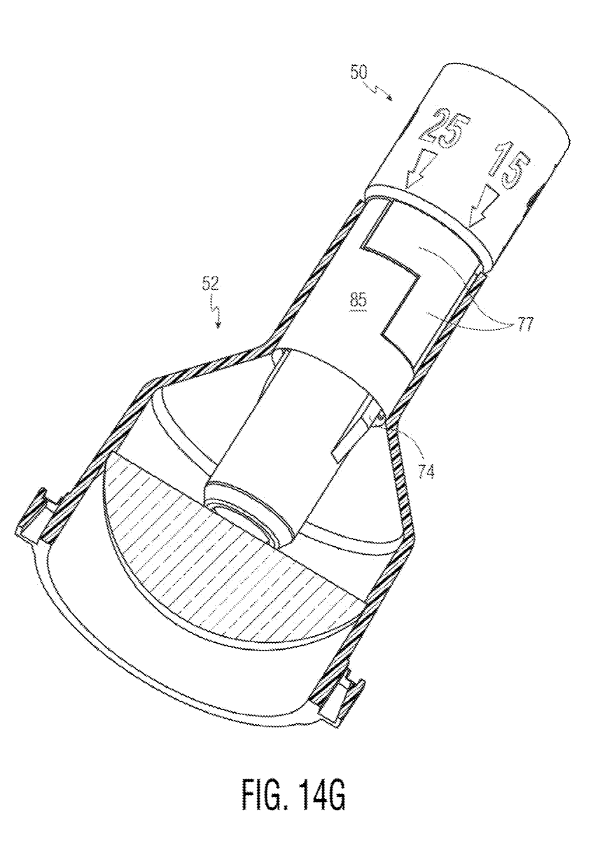

As shown by FIG. 6, radially extending mounting structure 44a of light fixture 34b is pinched between plates 40a and 40b. Left-shown part of plate 40a stops moving left within housing 20 by pressing against a necked-down portion of the housing starting at point 20a. As a result of leftward movement of plate 40a being thus stopped, the entire assembly of FIG. 5 can be conveniently pressed into the housing from its right-hand end in FIGS. 1 and 2. The assembly stops moving by virtue of the necked-down region of housing 20. Lens 24 is attached to the housing (not shown) by bolts (not shown).

FIGS. 7 to 14G describe the invention for a bayonet and receiver assembly disclosed in U.S. patent application Ser. No. 10/793,049 filed on Mar. 4, 2004. The foregoing application has different inventorship with the application assigned to the same assignee as the present application.

FIG. 7 shows a bayonet assembly 50 and cooperating receiver assembly 52, which holds a lens 54. These three components are essential parts of the light pipe fixture of the invention. By way of example, lens 54 may be a piano-convex lens, an aspherical lens, a holographic lens, a Fresnel lens or a flat lens, made from either glass or plastic.

Light pipe 56 is received into bayonet assembly 50 and secured in such assembly by an adhesive. As shown in connection with FIGS. 8A-8C, bayonet assembly 50 uses an internal lip 58 (FIG. 8C) to stop the inserted light pipe at a precise location. As shown in connection with FIGS. 9A-9B, receiver assembly 52 utilizes an internal shelf 60 (FIG. 9C) and radial snaps 62 (FIG. 90) to lock the lens into a precise location. With receiver assembly 52 being molded from Acrylonitrile Butadiene Styrene (ABS), for instance: radial snaps 62, preferably two in number, preferably occupy between about 5 and 20 degrees of circumference about a longitudinal axis 24 of such assembly, and more preferably between about 5 and 15 degrees. Preferably, the ABS for the receiver assembly is “platable” in that it can accept such coatings as chrome or brass, for reflective purposes,

FIGS. 10A-10C show respective, initial relative positions of bayonet assembly 50 and receiver assembly 52 for achieving light beam spreads exiting lens 54 of degrees of 15, 25 and 40, respectively, by way of example. In the positions shown, a notch 68 or other mark on receiver assembly 52 is aligned with markings on the bayonet assembly 50 for a desired degree of beam spread; for instance, FIG. 10A showing notch 68 aligned with “15” for a 15-degree beam spread. Each of the various beam spread adjustment locations is clearly marked on bayonet.

In more detail, a user inserts bayonet assembly 50 into receiver assembly 52 as shown in any of FIGS. 10A-10C until the bayonet assembly reaches a full stop within receiver assembly 50. The user then rotates the bayonet assembly relative to the receiver assembly in the direction of an arrow 70 until a full rotational stop is reached, at which point the bayonet assembly becomes locked to the receiver assembly. For the embodiment shown, the rotation of bayonet assembly 50 relative to receiver assembly 52 is 1/12^{th} turn, or 30 degrees.

The foregoing lock-in adjustment location ability of the bayonet & receiver assembly arrangement is made possible by appropriate contouring of the confronting surfaces of the bayonet assembly 50 and receiver assembly 52. With reference to FIG. 11, bayonet assembly 50 uses an axial stop ledge 72 and circumferential lock flange 74 that extend radially outwards from a substantially cylindrical surface 76, which is a surface that radially bears against cooperating surfaces of receiver assembly 52. Axial stop ledge 72 is axially aligned with lock flange 72. The additional geometric structures on the bayonet assembly (e.g. 77) allow for clearance for different beam-spread positions and may also block contaminants, as described below.

At this point, it should be noted that the described radially outwardly facing surface of bayonet assembly 50 forms a pattern from about 180 degrees about a longitudinal axis 78 of the assembly, which pattern repeats for the other approximately 180 degrees about such longitudinal axis. This same approximately 180-degrees repeating of patterns applies also to receiver assembly 52.

Now, referring to receiver assembly 52 of FIGS. 12A and 12B, receiving channels 80, circumferential flange stops 82 and axial positioning pads 84 are shown extending radially inwardly from a generally cylindrical surface 86. Flange stops 82 and positioning pads 84 are mounted on a radial bearing region 85, which extends towards axis 78 from surface 86. Radial bearing surface 85 supports radial bearing loads when the bayonet assembly is inserted into the receiver assembly, and structurally supports positioning pads 84. Another function of radial bearing surface 85 will be described below.

During insertion of bayonet assembly 50 (FIG. 11) into receiver assembly 52 (FIG. 12A), circumferential lock flange 74 (FIG. 11) is guided into a receiving channel 84 (FIG. 12A), such as vertically middle-shown channel 84, until axial stop ledge 72 (FIG. 11) abuts the vertically lowermost-shown positioning pad 84 (FIG. 12A). At this point, bayonet assembly 50 is then turned 30° clockwise relative to receiver assembly 52 so that circumferential lock flange 74 (FIG. 11) passes a cam lock point (or projection) 88 (FIG. 121) to lock the circumferential lock flange against a circumferential flange stop. In this position (not shown), a positioning pad 84 (FIG. 12A) is sandwiched in the axial space between circumferential stop flange 74 and axial stop ledge 72. This operation can be more easily understood with reference to FIGS. 13-13B and 14A-14C.

As in FIG. 11, FIG. 13A shows bayonet assembly 50 with axial stop ledge 72, circumferential lock flange 74 and additional structure 77. As in FIG. 12A, FIG. 13A also shows receiver assembly 52 with circumferential flange stops 82 and axial positioning pads 84. However, FIG. 13A has been simplified by omitting the mounting surface for these stops 82 and pads 84, as is shown at 85 in FIG. 12A; and FIG. 13B shows these structures as six stops 82a-82f and six pads 84a-84f. For practicality, it is preferred that the number of stops and pads be four, six (as shown) or eight.

With the foregoing structure in mind, the selection of a 15-degree beam spread is shown in FIGS. 14A-14C. FIG. 14A shows the insertion of circumferential lock flange 74 into the receiving channel 80 between axial positioning pads 84a and 84b. FIG. 148 show the final extent of insertion of lock flange 74, when axial stop ledge 72 abuts axial positioning pad 84a. Then, bayonet assembly 50 is then rotated 30 degrees clockwise relative to receiver assembly 52, as shown in FIG. 14C, at which point axial positioning pad 84b is sandwiched between axial stop ledge 72 and circumferential lock flange 74. At this point, also, axial stop ledge 72 stops rotating since it then abuts circumferential flange stop 82a. At this point, finally, as shown in the detail view of FIG. 14D, lock flange 74 has rotated past a cam lock projection 94 on positioning pad 84b, which locks in the bayonet assembly relative to the receiver assembly at the 15-degree beam spread position.

FIG. 14E shows bayonet assembly 50 and receiver assembly 52. This Figure shows assembly 52 partially in cross section and with an outer portion removed to show more clearly radial-bearing region 85, described above in connection with FIG. 12A. The enlarged view of FIG. 14F shows a radial-bearing region 85 of receiver assembly 52 supporting the positioning pads 84a and 84b. It further shows circumferential lock flange 74 of bayonet assembly 52 extending axially past positioning pad 84b, and circumferentially positioned so that it has started to pass under positioning pad 84b. Surface 72a of axial stop ledge 72 of the bayonet assembly axially abuts positioning pad 84b, similar to the position shown in FIG. 14B. Part of surface 72a, shown broken away, also abuts a portion of an annular shelf 95 of radial-bearing region 85. Upon rotating bayonet assembly 50 (FIG. 14E) clockwise in relation to receiver assembly (such rotation not shown in FIG. 14F): when viewing from right to left in FIG. 14F, surface 72a of stop ledge 72 continues to abut, and be supported by, annular shelf 95. Preferably, annular shelf 95 of radial-bearing region 85 forms a continuous annular surface with positioning pad 84b, which continuous annular surface fully supports the entire surface 72a of ledge 72. This provides a stable coupling between the bayonet and receiver assembly, and help assure that the locking action described above in connection with FIG. 12B will reliably occur.

In the embodiment illustrated herein, annular shelves such as that shown in FIG. 14F at 95 are associated with positioning pads 84b and 84c (FIG. 13B) but not with positioning pad 84a.

The above-described bayonet assembly 50 and receiver assembly 52 were designed as molded components, with bayonet assembly 50 of polycarbonate plastic and receiver assembly of platable ABS as mentioned above. This provides low cost and an easily reproducible product.

In addition, in the one of the three beam-spread positions in which the bayonet assembly is inserted the furthest into the receiver assembly, the present design blocks contaminants from reaching the fight pipe. In particular, such interstices are configured to block any direct path for contaminants to reach the light-dispensing end of the light pipe when the bayonet assembly is locked in position with the receiver assembly. This is shown in FIG. 14G, wherein structure 77 of bayonet assembly cooperates with radial-bearing region 85 of the receiver assembly to block a direct path for contaminants to reach the light pipe when the bayonet and receiver assemblies are locked together. Thus, although not sealed, the foregoing design is considered closed, since it does not allow a direct path for dust, spray, or insects to reach the light pipe end.

Many earlier designs were abandoned because the components were not easily moldable. The receiver assembly, in particular, was the most difficult to design for molding as a component that was closed to contaminants as described above. The small bore size of the receiver assembly's area for receiving the bayonet assembly—typically about 20 mm—made any common undercut (or snap pocket) impossible to mold. Although the use of exterior inserted slide cores in a mold would have made the bayonet and receiver assemblies easy to make and effective, the receiver assembly's bore size needed to be kept small to keep the costs of the components and associated tooling reasonable and practical, as well to allow for mounting practical component sizes. The illustrated design of the bayonet and receiver assemblies allows for the successful molding of these components, as well as maintaining the small bore size and closure of any direct path for contaminants to reach the light pipe end.

The foregoing describes a light arrangement that is exceedingly durable, efficient and can withstand jolting and even crushing forces that would destroy a conventional dock light arrangement or a light source in the arrangement.

While the invention has been described with respect to specific embodiments by way of illustration, many modifications and changes will occur to those skilled in the art. It is, therefore, to be understood that the appended claims are intended to cover all such modifications and changes as fall within the true scope and spirit of the invention.

What is claimed is:

1. A durable lighting arrangement, comprising:
a) a housing of generally cylindrical shape with a forward end for emitting light and a rearward end;
b) a light-transparent aperture located towards the forward end of the housing;
c) a light-transmitting conduit entering the housing rearwardly of the light-transparent aperture; and
d) at least one plate that is mounted to the housing perpendicular to a longitudinal axis of the housing, that has one or more light apertures, and that provides structural reinforcement to the generally forward area of said housing.

2. The durable lighting arrangement of claim 1, wherein the at least one plate comprises a plate having a rim that flares into a generally cylindrical portion for mating against an inner, generally cylindrical surface of the housing.

3. The durable lighting arrangement of claim 1, wherein:
a) the at least one plate comprises a pair of plates;
b) each plate has a peripheral rim that flares into a generally cylindrical portion for mating against an inner surface of the housing; and
c) the rims of the pair of plates are oriented outwardly with respect to a common area between the plates.

4. The durable lighting arrangement of claim 3, further comprising:
a) at least one light pipe-receiving assembly having a radially extending mounting; and
b) the radially extending mounting portion being sandwiched between the pair of plates and aligned with respective light apertures in each plate.

5. The durable lighting arrangement of claim 4, wherein:
a) the plates are mounted to each other; and
b) the at least one light-pipe receiving assembly is mounted to the plates as a result of being sandwiched between the plates.

6. The combination of the durable fighting arrangement of claim 1 and a remote light source for providing light to the light-transmitting conduit, wherein the light-transmitting conduit comprises a flexible fiber-optic conduit.

7. The arrangement of claim 1, further comprising one or more adjustable focusing optic elements to control spatial beam profile of light exiting said housing.

8. A durable lighting arrangement, comprising:
a) a housing of generally cylindrical shape with a forward end for emitting light and a rearward end;
b) a light-transparent aperture located towards the forward end of the housing;
c) a light-transmitting conduit entering the housing rearwardly of the light-transparent aperture; and
d) a pair of plates that is mounted to each other and being mounted to the housing perpendicular to a longitudinal axis of the housing, each plate having one or more light apertures; and
e) each plate having a peripheral rim that flares into a generally cylindrical portion for mating against an inner surface of the housing, with the rims of the plates being oriented outwardly with respect to a common area between the plates.

9. The durable lighting arrangement of claim 8, wherein the rim of the rearwardly disposed plate is seated rearwardly against a necked-down portion of the housing.

10. The durable lighting arrangement of claim 8, further comprising;
a) at least one light-pipe receiving assembly having a radially extending mounting portion;
b) the radially extending mounting portion being mounted to the pair of plates by being sandwiched between the pair of plates in alignment with respective light apertures in each plate.

11. The durable lighting arrangement of claim 10, wherein:
a) each of at least one light-pipe receiving assembly has a generally conically shaped portion; and
b) the generally conically shaped portion passes through a light aperture in a rearwardly mounted plate.

12. The durable fighting arrangement of claim 10, wherein each plate has a plurality of light apertures.

13. The durable lighting arrangement of claim 10, further comprising one or more adjustable focusing optic elements to control spatial beam profile of light exiting said housing.

14. The combination of the durable lighting arrangement of claim 10 and a remote light source for providing light to the light-transmitting conduit, wherein the light-transmitting conduit comprises a flexible fiber-optic conduit.
